(19) United States
(12) Patent Application Publication
(10) Pub. No.: US 2019/0357527 A1
(43) Pub. Date: Nov. 28, 2019

(54) Organ Perfusion Pump Reservoir Filter Device

(71) Applicant: Burnett Stephens Kelly, JR., Sacramento, CA (US)

(72) Inventor: Burnett Stephens Kelly, JR., Sacramento, CA (US)

(21) Appl. No.: 16/482,402

(22) PCT Filed: Jan. 16, 2018
(86) PCT No.: PCT/US2018/013785

§ 371 Date: Jul. 31, 2019

Related U.S. Application Data
(60) Provisional application No. 62/454,945, filed on Feb. 6, 2017.

(51) Int. Cl. A01N 1/02

(52) U.S. Cl. CPC A01N 1/0247; A01N 1/0278

(57) ABSTRACT

A perfusion pump circuit has a cassette for containing perfusion fluid and a perfusion pump to circulate perfusion fluid in and out of the cassette. A perfusion solution filtering device has a hemofilter and a pump coupled to the cassette to pump perfusion fluid out of the cassette, through the hemofilter, and back into the cassette.

### CROSS-REFERENCE TO RELATED APPLICATIONS

This application claims the benefit of U.S. Provisional Application No. 62/454,945, filed on Feb. 6, 2017.

### BACKGROUND

Transmission of viral and bacterial disease from organ donors to recipients is a significant transplant rate-limiting problem. As an example, hepatitis C virus (HCV) is a 30-65 nanometer viral particle that infects millions of people in the US and approximately 15-20% of potential organ donors. Transmission of HCV is thought to occur with minimal viral inoculum. In the present healthcare environment, the standard of care for HCV+ patients with no contraindications or sequelae of cirrhosis-induced portal hypertension (Child-Pugh A), is to treat with anti-viral therapy and in 80, 65, 50% of these patients a sustained viral response (SVR) is achieved over 12, 24, and 48 months respectively. Patients with SVR have a demonstrated survival advantage over patients who have not received therapy or those without SVR. Thus, to prevent transmission of an unknown viral load and genotype from an organ donor to a waitlisted recipient, many otherwise functional organs (particularly kidneys) are discarded due to a lack of identified waitlisted patients who are HCV RNA positive. Other donor organs such as the lungs and heart are rarely even considered for transplant due to the significant morbidity that can be incurred in recipients of these organs. Thus, a tremendous opportunity to utilize viable organs from this underappreciated patient source population is not being optimally engaged.

### BRIEF DESCRIPTION OF THE DRAWINGS

FIG. 1 is a block diagram of perfusion pump circuit and solution viral clearance pump.

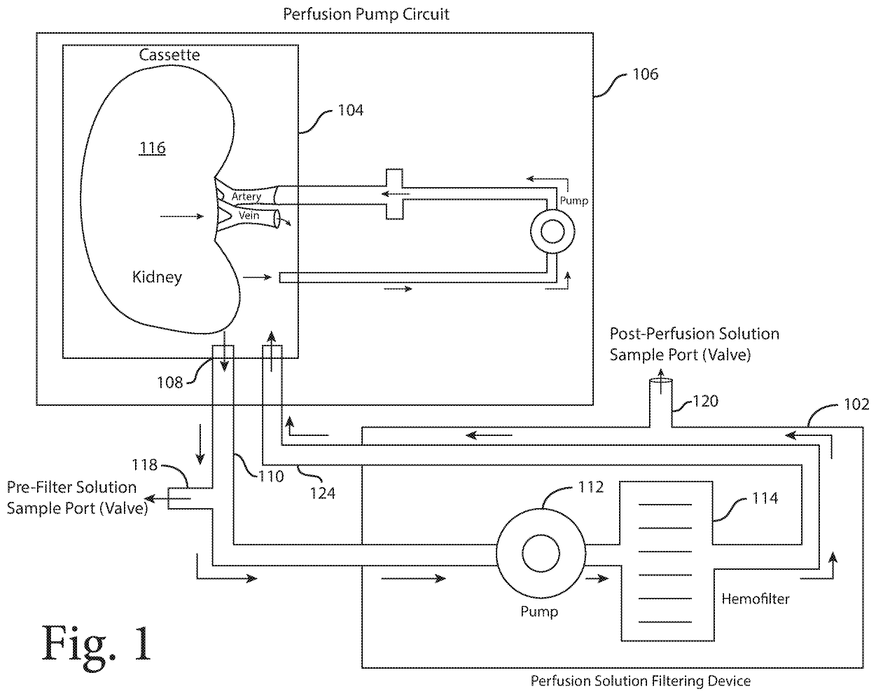

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Problem 1. Viable and transplantable organs from HCV+ organ donors have a significantly higher discard rate and overall utilization rate than non-HCV organ donors because of the theoretical risk of HCV transmission to a viral load negative or different HCV genotyped recipient.

In many U.S. organ procurement organizations (OPO's), HCV+ donors may represent 5-40% of organ donors during a year. There are presently over 120,000 waitlisted patients with an estimated death rate of 7-8 patients dying daily without the opportunity for transplant. [UNOS Data, 2016] The majority of these waitlisted patients are awaiting renal transplant. For hemodialysis patients, there is an estimated risk of annual mortality exceeding 50%. The life benefit of renal transplantation has been realized within 3 years of wait-listing, and further life-year benefit has been demonstrated for certain ESRD patients who receive pre-emptive transplant prior to initiating dialysis. With an estimated 15-20% of the US renal transplant waitlist being composed of HCV+ patients, there is some theoretical benefit to identifying a strategy to safely utilize any quality kidney (including from a HCV+ donors). It is further estimated that hemodialysis patients have a 40-50% incidence of HCV.

Present Practice and Assumptions Regarding the Use of HCV Positive Organs for Transplantation:

An increasing percentage of organ donors engage in high-risk behaviors such as IV drug use and sexual/hygiene practices that may predispose them to carrying asymptomatic viral hepatitis that was not previously diagnosed prior to conducting the organ donation evaluation.

During the organ donation evaluation, the testing identifies antibodies (acute IgM and chronic carrier IgG fractions) to viral infections as well as the presence of active nuclear antigens (NAT testing). No viral load or genotype testing is conducted due to cost and practicality in the present accepted organ allocation process.

Treatment of HCV+ recipients post-transplant is not yet the gold-standard, and may be outcome limited by mixed donor/recipient HCV genotypes, and immunosuppression strategies over the life-span of the organ.

Pulsatile Perfusion

Cold pulsatile perfusion for kidneys was introduced into clinical practice in the 1990's, with the hypothesis that perfusion of the renal vasculature by either continuous roller pump or intermittent pulsatile flow dynamics would maintain cellular metabolic arrest while “opening” the microvasculature of the kidney. Organ preservation solution is “pumped” through a sterile enclosed fluid circuit composed of the pump, non-distensible tubing, a porous air-trap and large particle filter, and affluent/effluent circuit flow probes. With continued experience, the flow/pressure dynamics have been interpreted to provide additional predictive information on the post-reperfusion function of the kidney in the recipient. The ideal kidney for transplant would be defined as a kidney with a Kidney Donor Predictive Index Score<80 (KDPI<80), a favorable renal biopsy result, normal renal anatomy, low pump resistance (<0.2), and renal artery flow>100.

Premise of the Preservation Pump Reservoir Filtering System

The premise of the preservation pump reservoir filtering system is to filter deleterious viral (and potentially bacterial) particles from the organ effluent during the pulsatile preservation process in an attempt to lower the remaining inoculum in the organ below the threshold of clinical disease transmission. By diminishing the circulating viral (or bacterial) load in the organ perfusion circuit and replenishing the blood-containing preservation solution, the transplanted viral inoculum will be diminished, rendering the viral antibody positive recipient more likely to be immune to low-dose viral exposure, and more likely to be responsive to post-transplant antiviral therapy.

Device Details

The perfusion solution filtering device 102 will be an external device that connects to the existing lid of the sterile organ cassette 104 of the organ perfusion pump 106 via a Luer lock port 108, or similar device, on the organ cassette lid. Alternatively, the sterile organ cassette 104 could be accessed through a different entry point, not on the lid. Sterile silastic tubing 110 will insert through the lid port (or other entry point) down into the most gravity dependent portion of the organ reservoir 104. The tubing 110 will sterilely connect to the perfusion solution filtering device 102 containing a pump 112 that will draw fluid from the well and push it through a hemofilter 114 (Aethlon Medical). The filtered effluent will then return to the sterile organ cassette 104 for continued pulsatile preservation of the organ 116. At the inflow 118 and outflow 120 channels of the device 102 will be Luer lock specimen sampling ports, or similar devices, to measure viral or bacterial load or to infuse therapy or fresh preservation solution to improve particle clearance. The filter pump circuit, which includes the perfusion solution filtering device 102, the input tubing 110 and the output tubing 124, will be primed with 250-500 cc of fresh perfusion solution to promote fluid exchange without introduction of air into the system. Once the organ perfusion is completed, the filtering pump lines 110, 124 can be removed, and the lid ports or other access ports are capped for standard removal of the organ from the pump for transplantation. The filter cartridge and tubing 102, 110, 124 are a disposable unit that can be removed from the filter pump housing for hazardous waste discard at the completion of use. The pump 112 does not require any calibration or additional maintenance.

While the description and FIGURE herein illustrate the use of the Preservation Pump Reservoir Filtering System with a kidney, it will be understood that the system can be used with all potential perfused organs. Further, the system is designed to filter all transmissible virus and bacteria and is not limited to those specific virus and bacteria mentioned herein.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

In one aspect, an apparatus includes a perfusion pump circuit having a cassette for containing perfusion fluid and a perfusion pump to circulate perfusion fluid in and out of the cassette. The apparatus includes a perfusion solution filtering device having a hemofilter and a pump coupled to the cassette to pump perfusion fluid out of the cassette, through the hemofilter, and back into the cassette.

Implementations may include one or more of the following. The apparatus may include input tubing connecting the perfusion pump circuit to the perfusion solution filtering device by which fluid is drawn from the perfusion pump circuit and delivered to the pump and output tubing connecting the perfusion solution filtering device to the perfusion pump circuit by which fluid is pumped from the hemofilter to the perfusion pump circuit. The apparatus may include a port into the input tubing, and a port into the output tubing. The cassette may be constructed to contain an organ. The perfusion solution filtering device, the input tubing, and the output tubing may be disposable. The input tubing may be inserted into the most gravity dependent portion of the perfusion pump circuit. The pump in the perfusion solution filtering device may not require calibration.

In one aspect, a method includes coupling a perfusion pump circuit to a perfusion solution filtering device. The perfusion pump circuit may have a cassette for containing perfusion fluid and an organ to be perfused and a perfusion pump to circulate perfusion fluid in and out of the cassette. The perfusion solution filtering device may have a hemofilter and a pump coupled to the cassette to pump perfusion fluid out of the cassette, through the hemofilter, and back into the cassette.

Implementations may include one or more of the following. The method may include running the perfusion solution filtering device until the organ perfusion is completed and disconnecting and discarding the perfusion solution filtering device. Coupling the perfusion pump circuit to the perfusion solution filtering device may include coupling the perfusion pump circuit to the perfusion solution filtering device with an input tubing by which fluid is drawn from the perfusion pump circuit and delivered to the pump and coupling the perfusion solution filtering device to the perfusion pump circuit with an output tubing by which fluid is pumped from the hemofilter to the perfusion pump circuit. The method may include running the perfusion solution filtering device until the organ perfusion is completed and disconnecting and discarding the perfusion solution filtering device, the input tubing, and the output tubing.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An apparatus comprising:
a perfusion pump circuit having:
a cassette for containing perfusion fluid, and
a perfusion pump to circulate perfusion fluid in and out of the cassette;
a perfusion solution filtering device having:
a hemofilter, and
a pump coupled to the cassette to pump perfusion fluid out of the cassette, through the hemofilter, and back into the cassette.

2. The apparatus of claim 1 further comprising:
input tubing connecting the perfusion pump circuit to the perfusion solution filtering device by which fluid is drawn from the perfusion pump circuit and delivered to the pump, and
output tubing connecting the perfusion solution filtering device to the perfusion pump circuit by which fluid is pumped from the hemofilter to the perfusion pump circuit.

3. The apparatus of claim 2 further comprising:
a port into the input tubing, and
a port into the output tubing.

4. The apparatus of claim 1 wherein the cassette is constructed to contain an organ.

5. The apparatus of claim 2 wherein the perfusion solution filtering device, the input tubing, and the output tubing are disposable.

6. The apparatus of claim 2 wherein the input tubing is inserted into the most gravity dependent portion of the perfusion pump circuit.

7. The apparatus of claim 1 wherein the pump in the perfusion solution filtering device does not require calibration.

8. A method comprising:
coupling a perfusion pump circuit to a perfusion solution filtering device;
wherein the perfusion pump circuit has:
a cassette for containing perfusion fluid and an organ to be perfused, and
a perfusion pump to circulate perfusion fluid in and out of the cassette;
wherein the perfusion solution filtering device has:
a hemofilter, and
a pump coupled to the cassette to pump perfusion fluid out of the cassette, through the hemofilter, and back into the cassette.

9. The method of claim 8 further comprising:
running the perfusion solution filtering device until the organ perfusion is completed; and
disconnecting and discarding the perfusion solution filtering device.

10. The method of claim 8 wherein coupling the perfusion pump circuit to the perfusion solution filtering device comprises:
coupling the perfusion pump circuit to the perfusion solution filtering device with an input tubing by which fluid is drawn from the perfusion pump circuit and delivered to the pump, and
coupling the perfusion solution filtering device to the perfusion pump circuit with an output tubing by which fluid is pumped from the hemofilter to the perfusion pump circuit.

11. The method of claim 10 further comprising:
running the perfusion solution filtering device until the organ perfusion is completed; and
disconnecting and discarding the perfusion solution filtering device, the input tubing, and the output tubing.
